(19) United States
(12) Patent Application Publication
(10) Pub. No.: US 2025/0178284 A1
(43) Pub. Date: Jun. 5, 2025

(54) Method and Control Device for Controlling an Irradiation in a Manufacturing Process for the Additive Manufacturing of Objects

(71) Applicant: EOS GMBH ELECTRO OPTICAL SYSTEMS, Krailling (DE)

(72) Inventors: Dominik Kunz, Gauting (DE); Harald Krauss, Gersthofen (DE); Peter Holfelder-Schwalme, Saal an der Donau (DE)

(21) Appl. No.: 18/956,310

(22) Filed: Nov. 22, 2024

(30) Foreign Application Priority Data
Dec. 5, 2023 (EP) 23214421.2

(51) Int. Cl. B29C 64/393; B29C 64/264; B33Y 10/00; B33Y 30/00; B33Y 50/02

(52) U.S. Cl. CPC B29C 64/393; B29C 64/264; B33Y 10/00; B33Y 30/00; B33Y 50/02

(57) ABSTRACT

Disclosed is a method for regulating an irradiation in a manufacturing process for the additive manufacturing of objects. The method involves identifying shape-regions in object layers to be solidified and categorizing them into reference-regions and correction-regions. Target-temperature maps are created to specify desired heat distribution for the correction-regions. Reference-regions are solidified while recording spatial temperature data, which is used to generate correction factor modules. These modules contain spatially resolved correction factors for irradiation values and are assigned to the corresponding correction-regions. The correction-regions are solidified using their respective correction factor modules, ensuring precise heat distribution and improved solidification accuracy.

### TECHNICAL FIELD OF THE INVENTION

The invention relates to a method and a regulation device for regulating an irradiation in a manufacturing process for the additive manufacturing of objects, a control device for a manufacturing device for the additive manufacturing of objects and a manufacturing device for the additive manufacturing of at least one object in an additive manufacturing process.

### BACKGROUND OF THE INVENTION

Additive manufacturing processes are becoming increasingly relevant in the production of prototypes and now also in series production. In general, “additive manufacturing processes” are manufacturing processes in which a manufacturing product (“object”) is built up by depositing material (the “building material”), usually on the basis of digital 3D design data. The structure is usually built up in layers. The term “3D printing” is often used as a synonym for additive manufacturing, the production of models, samples and prototypes using additive manufacturing processes is often referred to as “rapid prototyping”, the production of tools as “rapid tooling” and the flexible production of series components as “rapid manufacturing”. As mentioned at the beginning, a key point is the selective solidification of the building material, wherein this solidification can take place in many manufacturing processes with the help of irradiation with radiation energy, e.g. electromagnetic radiation, in particular light and/or heat radiation, but possibly also with particle radiation such as electron radiation.

Examples of processes that work with irradiation are “selective laser sintering” or “selective laser melting”. In this process, thin layers of a mostly powdery building material are repeatedly applied on top of each other and in each layer the building material is selectively solidified in a “welding process” by spatially limited irradiation of the areas that are to be part of the object to be manufactured after production, in which the powder grains of the building material are partially or completely melted with the help of the energy introduced locally at this point by the radiation. During cooling, these powder grains then solidify together to form a solid. In most cases, the energy beam is guided along solidification paths across the construction field and the remelting or solidification of the building material in the respective layer takes place in the form of “weld paths” or “weld beads”, so that ultimately a large number of such layers formed from weld paths are present in the object. In this way, objects of very high quality and breaking strength can now be produced.

During production, the energy introduced by the energy beam may be absorbed inhomogeneously by the object. This manifests itself in areas of an object layer with an inhomogeneous heat distribution. Sometimes it may be desirable to solidify selected areas with a different energy input, but this is generally undesirable, especially in the case of uniform surfaces or regular contours.

### SUMMARY OF THE INVENTION

It is an object of the present invention to provide a method and a regulation device for regulating an irradiation in a manufacturing process for the additive manufacturing of objects, which overcome the disadvantages of the prior art and in particular allow an improvement in the quality of objects and a homogeneous quality of the manufactured objects. Preferably, one task of the invention is to increase the stability of the manufacturing process and, in particular, to prevent an interruption of the manufacturing process or to prevent problems with the application of the build-up material at points with increased heat generation or heat radiation.

This object is solved by a method, a regulation device, a control device and a manufacturing device.

A method according to the invention is used to regulate irradiation in a manufacturing process for the additive manufacturing of objects. In this process, building material is solidified layer by layer in a construction field in the form of object layers, corresponding to cross-sections of the objects to be produced, by means of irradiation of the building material.

The method comprises the following steps:
determining a plurality of shape-regions corresponding to each other in shape and/or size in the object layers to be solidified,
selecting a number of reference-regions from the plurality of shape-regions, at least the remaining shape-regions being defined (or regarded) as correction-regions,
determining a number of target-temperature maps which specify a desired heat distribution of correction-regions or a number of groups of correction-regions,
solidifying a number of selected reference-regions and recording spatially resolved temperature data of the number of reference-regions as they are solidified,
generating a number of correction factor modules for the correction-regions from the temperature data and the target-temperature maps, wherein each correction factor module specifies spatially resolved correction factors for irradiation values or spatially resolved corrected irradiation values and assigns a correction factor module to each correction-region,
solidifying at least the correction-regions based on the respectively assigned correction factor module.

The method advantageously regulates the irradiation of a production process by correcting the irradiation. A correction relates to the energy introduced into a region. In particular, a correction factor module can influence the intensity of an irradiation and/or the duration of an irradiation. If the temperature data is used to determine that a region (a reference-region) has absorbed too much or too little heat during solidification, e.g. has been irradiated too strongly or too weakly, or emits heat too quickly or too slowly after solidification, the irradiation can be adjusted according to other regions (the correction-regions) using the correction factor module, i.e. the energy input can be optimized. This ensures that the amount of heat (i.e. the heat absorbed or emitted by the component or a component area) is similar or adapted to the specific location during the production of the component. A similar, in particular constant, amount of heat advantageously results in mechanical stresses within the component being minimized and/or a homogeneous (in particular desired or minimal) degree of porosity of the component being achieved. In addition, an adapted amount of heat is advantageous so that different component areas with different properties can be built. Different properties can be or relate to, for example, mechanical strength, porosity, microstructure, crystal structure or crystal phase.

For the reference-regions, optimization is no longer possible in this version of the method according to the invention. However, as the objects are built up layer by layer, it is not necessarily dramatic if a layer has been solidified slightly too hot or cold. However, “sacrificial objects” can also be specifically determined, which are later segregated and which then contain the reference-regions.

Several “shape-regions” are defined as part of the process. These shape-regions are regions in an object to be manufactured and/or in several objects to be manufactured that correspond to each other in shape and/or size. Preferably, both the shape and the size of the shape-regions are at least similar.

The characteristic that two shape-regions correspond in shape means that they are identical or at least similar in shape. This can be the geometric shape of the shape-regions. For example, two shape-regions are polygons and have an identical shape (i.e. they have the same number of edges and identical angles between two consecutive edges). Alternatively, for example, two shape-regions are polygons and have a similar shape (i.e., the polygons are congruent over a portion of each of their perimeters or the polygons have the same number of edges, with the angles between the edges differing within an interval).

The characteristic that two shape-regions correspond to each other in size means that they are identical or at least similar in size. The size of a shape-region can be its surface area, in particular its geometric area. For example, two shape-regions have identical size, if their area is identical or two shape-regions have a similar size, if their regions are different within an interval. Two shape-regions can be identical in shape but not in size, or vice versa. However, it is also possible that the shape-regions correspond in shape and size, i.e. that they are identical or at least similar in terms of their shape and/or size.

As mentioned at the beginning, the shape-regions are defined in the object layers. Object layers of different objects can be defined as shape-regions. In addition, it is particularly possible for object layers of identical objects to be defined as shape-regions. In this case, it should be noted that it is not absolutely necessary for the objects to be all manufactured in one and the same production process. The temperature data of reference-regions and correction factor modules in one production process can also be used for other production processes. When defining the shape-regions in the object layers, parts of the object layers can also be defined as shape-regions. In this case, parts of different object layers (i.e. object layers from different objects) can be defined as shape-regions. It is also possible for several parts of the same object layer and, if necessary, parts of other object layers to be defined as shape-regions at the same time. In one example, the sub-areas can be areas of one and the same object, e.g. the points of a star.

It should also be noted that although shape-regions must be defined at the beginning of the procedure so that reference-regions can be selected, further shape-regions can also be defined later, after shape-regions have been solidified.

In particular, it should be noted that shape-regions do not necessarily have to be determined to the same layer (even if this is a preferred embodiment). It can happen that identical objects are shifted in height in relation to each other or that identical shape-regions in an object appear at different heights.

There can also be different groups of shape-regions. Then the procedure can be carried out for each group by selecting reference-regions for each group and creating the correction factor modules for the respective group from the temperature data for these reference-regions.

It should be noted that not all regions that are similar in shape and/or size necessarily have to be assigned to the shape-regions. For example, if there are many identical objects, some of the objects can simply be ignored in the process. Nevertheless, for a better understanding, it is still possible to imagine that several identical objects are to be formed and that the identical layers of these objects represent shape-regions of a group.

It should also be noted that not all regions that are similar in shape and/or size necessarily have to be assigned to a group of shape-regions. For example, shape-regions of one layer can be assigned to a group of shape-regions and identical shape-regions (to these shape-regions) of another layer can be assigned to another group of shape-regions.

At least one reference-region is selected from the defined shape-regions. This reference-region is a region in which the temperature data is measured. In a simple example, one can imagine that at least one reference-region is solidified, then (or in the meantime) its heat distribution is measured, e.g. by taking a picture with an IR camera, and then the correction factor modules for correcting the correction-regions are determined from this.

“Reference-regions” and “correction-regions” are both shape-regions. A shape-region is always a correction-region and/or a reference-region. Preferably, any other region is not considered a shape-region (even if it is similar in shape and/or size), as it is not considered by the method. A shape-region whose temperature data is measured is a reference-region, a shape-region whose solidification is corrected is a correction-region. A shape-region whose solidification is corrected and whose temperature data is measured in the process is both a reference-region and a correction-region.

A shape-region can therefore be both a correction-region and a reference-region, e.g. in the case where a first reference-region is selected, a correction factor module is determined from its temperature data so that a correction-region is corrected and this correction-region is then defined as a new reference-region in order to determine another correction factor module with its temperature data for a further, improved correction. This means that the reference-regions do not necessarily all have to be selected at the beginning, but a reference-region must be selected before the first correction-region is corrected and the last reference-region should be selected at the latest before the last correction-region is corrected.

However, it should be noted that the definition of shape-regions and the selection of reference-regions does not necessarily have to be completed with the production of a series of objects. If a new series of (identical or similar) objects is to be produced some time later, the previously determined correction factor modules can be used. Reference-regions can also be selected again in the new series to determine whether the “old” correction factor modules can be applied.

To determine the correction factor modules, you need not only the temperature data of the reference-regions (a potential “is” state, so to speak), but also information about a desired state, in particular about a desired state for a correction-region. According to the invention, at least one correction-region is defined and the desired state (a “target” state to be achieved, so to speak) of the correction-region is represented or defined by the (two-dimensional) target-temperature maps. The target-temperature map preferably represents a non-uniform distribution of values. Further preferably, the target-temperature map is two-dimensional and the values (for the sake of clarity, the values of the target-temperature map are also referred to as “target-temperature values” in the following) are specified in the target-temperature map in a location-specific manner. This means that a correspondence between a target heat value and a position in an object layer is given or can be reconstructed. In the following, this is also expressed in such a way that a target-temperature map is location-specific or that a location-specific target-temperature map is provided or available. However, a uniform distribution of target-temperature values in the target-temperature map is also possible. In particular, a target-temperature map can consist of a single value (target heat value).

A target heat value is preferably a scalar value that represents an amount of heat. A heat amount, in particular when represented as a scalar value, can be an integral under a heat radiation curve or spectrum or a temperature. Furthermore, a target heat value can be an absolute or a relative value, wherein a relative target heat value can refer to a change in comparison to another target heat value or to a predetermined target value (e.g. a calibration value). An absolute heat value can, for example, be an absolute temperature or an amount of heat or energy in J/mm². A relative heat value is, for example, a temperature difference. In particular, a target-temperature map can consist of so-called “gray values”. A gray value is an indicator of thermal radiation (IR radiation) that can be correlated with a temperature, for example based on a calibration. A gray value can result from an electrical signal, e.g. when the thermal radiation is recorded with a CCD or CMOS camera, and can be correlated with a heat amount and/or with a temperature, e.g. on the basis of a calibration. For example, the gray values can correspond to an absolute or relative temperature or an absolute or relative value for an amount of heat, e.g. a scalar value as an integral under a thermal radiation curve or spectrum.

A target-temperature map is preferably defined for a correction-region. This means that an individual target-temperature map can be assigned to each correction-region. Alternatively, a target-temperature map could be assigned to a group of correction-regions or all correction-regions. In the case of identical objects, correction-regions of all objects can be assigned a single target-temperature map. In the two-dimensional case of a target-temperature map, identical target-temperature maps can be available for identical objects. If target-temperature maps of identical objects consist of a single value (target-temperature value), this value can be the same for all identical objects. This value can, for example, only be a single target temperature or a single target heat value. However, different objects can also be assigned different target-temperature maps. As already mentioned, the target-temperature values of a target-temperature map can be location-specific. A location-specific target-temperature map can be defined for a correction-region in such a way that a correspondence between a target-temperature map value and a position in the correction-region is given or can be reconstructed.

In a location-specific target-temperature map, the target heat values can be distributed in such a way that their distribution takes into account certain areas in the correction-region. Preferably, it is possible to define areas within a correction-region that should be corrected differently than other areas of a correction-region. e.g. it may be advantageous to correct edge areas or small structures in a correction-region differently than large and/or central areas.

As already indicated, the things described above (shape-regions, reference-regions, target-temperature maps) can all be defined at the beginning of the process.

However, for the part where reference-regions of a layer are solidified and temperature data is recorded, basically only the reference-regions to be solidified need to be known. This does not necessarily have to be done before the first correction. As already indicated above, a reference-region can be consolidated and its temperature data used for a correction, then further reference-regions can be determined (possibly also corrected) and further temperature data recorded.

The temperature data is spatially resolved. This means that several heat values are measured at different positions in a reference-region and assigned to these positions. In this respect, a grayscale image recorded with an IR camera is preferred. The grayscale image recorded with the IR camera corresponds to a heat distribution and/or a temperature; i.e. a (each) position in the grayscale image reflects a heat amount and/or temperature from a corresponding position in the reference-region. The amount of heat and the temperature can be recorded or mapped as an absolute or relative value as already described. For example, absolute or relative temperatures or an absolute or relative value, e.g. a scalar value as an integral under a heat radiation curve or a heat radiation spectrum, can be depicted in the grayscale image. For example, a heat amount can be mapped with gray values.

The temperature data is measured during the solidification of a reference-region. This means (directly) after or during solidification. Recording during solidification gives more accurate values, as the areas that solidify first are recorded before they cool down. It can therefore be summarized that the temperature data basically reflect the heat distribution of the reference-regions.

If you now have temperature data for at least one reference-region (the actual state) and the target-temperature maps, a correction factor module can be calculated. This can simply be done in such a way that less heat is introduced into a correction-region in places where the reference-region was too hot (the temperature data there was above the corresponding temperature values of the target-temperature maps) and more heat is introduced in places where parts of the reference-region were too cold (the temperature data there was below the corresponding temperature values of the target-temperature maps). A suitable calculation of a correction factor module can be easily determined by means of tests.

A correction factor module specifies spatially resolved correction factors for irradiation values, i.e. factors with which specified irradiation values are offset (e.g. multiplied) in order to obtain corrected irradiation values. Alternatively, a correction factor module also specifies corrected irradiation values that are already spatially resolved.

A correction factor module must be assigned to each correction-region so that a correction can be carried out.

The correction-regions are then solidified based on the correction factor module assigned to them.

A regulation device according to the invention is used to regulate irradiation in a manufacturing process for the additive manufacturing of objects. In this process, building material is solidified layer by layer in a construction field in the form of object layers corresponding to cross-sections of the objects to be produced by means of irradiation of the building material. The regulation device comprises the following components:
a provision-unit designed for
   i) determining a plurality of shape-regions corresponding to each other in shape and/or size in the object layers to be solidified,
   ii) selecting a number of reference-regions from the plurality of shape-regions, at least the remaining shape-regions being defined as correction-regions,
   iii) determining a number of target-temperature maps which specify a desired heat distribution of correction-regions or a number of groups of correction-regions,
a sensor unit designed for recording spatially resolved temperature data of the number of reference-regions as they are solidified,
a correction module unit designed for generating a number of correction factor modules for the correction-regions from the temperature data and the target-temperature maps, wherein each correction factor module specifies spatially resolved correction factors for irradiation values or spatially resolved corrected irradiation values and assigns a correction factor module to each correction-region,
a control data unit designed for generating and outputting control data for solidifying at least the correction-regions based on the respectively assigned correction factor module.

The regulation device is preferably designed to carry out a process according to the invention. The function of the components of the device has already been described above.

The provision-unit may well have several different sub-units that fulfill the different tasks. These sub-units can be assigned to the provision-unit solely on the basis of their function of determining or selecting.

The sensor unit is preferably an infrared camera, but can also be another heat sensor. It is not absolutely necessary for the sensor unit to be able to indicate an absolute temperature (e.g. if the aim of the method is merely to homogenize the heat input), but it is advantageous if the sensor unit is calibrated, e.g. if specific temperatures are assigned to certain shades of grey in a greyscale image from an IR camera.

The correction module unit can be a simple computing unit, but it can also be designed to generate control command parts for irradiation for additive manufacturing of objects based on the number of correction factor modules.

The control data unit is designed to provide generated control data to a control device for additive manufacturing of objects.

A control device according to the invention for a manufacturing device for the additive manufacturing of objects comprises a regulation device according to the invention. Alternatively or additionally, it is designed to control the manufacturing device in accordance with a method according to the invention.

A manufacturing device according to the invention is used for the additive manufacturing of at least one object in an additive manufacturing process. In principle, manufacturing devices for additive manufacturing are known and comprise at least one irradiation device for solidifying building material layer by layer by irradiation with at least one energy beam. The manufacturing device according to the invention additionally comprises a control device according to the invention.

In particular, the invention can be realized in the form of a computer unit with suitable software. The computer unit may, for example, have one or more cooperating microprocessors or the like for this purpose. In particular, it can be realized in the form of suitable software program parts in the computer unit. A software-based realization has the advantage that even computer units already in use can be easily updated by a software or firmware update in order to work in the manner according to the invention. In this respect, the task is also solved by a corresponding computer program product with a computer program which can be loaded directly into a memory device of a computer unit, with program sections to carry out all the steps of the method according to the invention when the program is executed in the computer unit. In addition to the computer program, such a computer program product may comprise documentation and/or additional components, including hardware components such as hardware keys (dongles, etc.) for using the software.

A computer-readable medium, for example a memory stick, a hard disk or another transportable or permanently installed data carrier, on which the program sections of the computer program that can be read in and executed by a computer unit are stored, can be used for transport to the computer unit and/or for storage on or in the computer unit.

Further, particularly advantageous embodiments and further embodiments of the invention result from the following description and, in particular, individual features of different embodiments or variants can also be combined to form new embodiments or variants.

Preferably, reference-regions and correction-regions are shape-regions of different objects. Alternatively or additionally, reference-regions and correction-regions are located in the same object, wherein reference-regions of directly overlapping layers do not overlap, so that temperature data of a reference-region is not falsified by an uncorrected layer below it.

It is preferred that in one embodiment of the method, a plurality of groups of shape-regions are defined in different layers and the method steps are carried out for each group of shape-regions. Preferably, groups of shape-regions are defined in S superimposed layers, so that preferably a plurality of stacks of shape-regions are present, which are formed from superimposed shape-regions of different groups of shape-regions. In the case of identical objects, the shape-region stacks could be the object layers, but also areas in one and the same object.

Preferably, other data can be recorded in addition to the temperature data, in particular gas flows or oxygen concentrations, when solidifying a reference-region.

As noted above, it is possible to define further forming regions (correction-regions and/or reference-regions) during or after solidification of a region, in particular depending on an observed process progression. It can be advantageous to make a correction only when a process deviation or irregularity has been detected. For this purpose, it is preferable to first select a reference-region from the defined shape-regions, solidify it, record temperature data and compare it with a target-temperature map. If the temperature data matches the target-temperature map within a defined range, no correction is made and a next shape-region is selected as the reference-region. This continues until the temperature data is no longer within the defined range, i.e. it deviates from the target-temperature map. Subsequently solidified shape-regions can then be corrected as correction-regions. In particular, a number of shape-regions can be defined successively, i.e. the next shape-region after a reference-region has been solidified. If it is then determined during the solidification of an region that a correction is necessary. A search is then made for similar (non-solidified) regions in the objects to be solidified, which then represent a shape-region group. The solidified region is then a reference-region of this shape-region group.

Preferably, from each group of shape-regions (shape-region groups) several shape-regions are selected in N objects, in particular N shape-region stacks, and from the selected shape-regions in each layer (alternating or in turn) M reference-regions are selected with M<N. In the groups, the M can be different in each case so that there are basically a number of N Mᵢ-values (i=1, 2, . . . , N).

Preferably, the selected shape-regions, in particular the shape-region stacks, correspond to the object layers of an object. Alternatively or additionally, an object is preferably divided into several shape-region stacks.

It is preferred that for a current layer (i.e. in particular for several object layers lying in this layer) a plurality of reference-regions is selected from the shape-regions of the layer and temperature data of these reference-regions are recorded. Alternatively or additionally, temperature data of reference-regions of a number of layers under the current layer can also be provided. In principle, older temperature data can be taken into account, even if it does not originate from the current production process. However, it is preferable to always consider (at least partially) temperature data from the current production process, as production processes can differ systematically, e.g. due to different external factors. Correction factor modules for the correction-regions of the current layer are then generated from the aforementioned temperature data and the relevant target-temperature maps.

Temperature data from different reference-regions is therefore used here. These can come from different reference-regions of the same layer or from different layers. In this case, it is preferable that a (preferably weighted) average value is calculated from the temperature data. Alternatively, it is preferred that several correction factor modules are first calculated for different temperature data and that an average value, preferably weighted, is calculated from these correction factor modules.

Preferably, the target-temperature map for a correction-region of temperature data can depend on a reference-region. This would be the case, for example, if only a homogenization of the heat distribution is to take place. For example, a value of the temperature data could then be selected, e.g. the minimum value, the maximum value or an average value, and the target-temperature map would then be this selected value or a predetermined value distribution based on this value.

According to a preferred embodiment of the method, a correction factor module KFM for a correction-region KB is determined by means of a correction function f from the temperature data WD(RBᵢ) of a number of n reference-regions RBᵢ and the target-temperature map SW(KB) for this correction-region KB according to KFM(KB)=f(WD(RB₁), WD(RB₂), . . . . WD(RBₙ), SW(KB)) is determined. The correction factor module can be or include this correction function or can be an instruction to use the correction function for correction. For a good understanding, one can imagine that the correction factor module is defined by the correction function. When generating the correction factor module, the correction function is preferably adapted in such a way that the corresponding correction factors for the irradiation result when the considered temperature data and target-temperature maps are entered into the correction function.

It is preferable that different correction functions f(i.e. also different correction factor modules) are used for different correction-regions (at different positions, e.g. in different rows on the construction field). The correction functions can be location-dependent. The use of different correction functions for different correction-regions is particularly advantageous if different regions are corrected differently from one another. It is possible for correction-regions that are located at different positions on the construction field to be corrected differently depending on their position on the construction field. This can be related, for example, to a gas flow direction or gas distribution and/or to a temperature distribution and/or to the heat distribution or dissipation in the component. It is also possible that different correction-regions are located at different positions in an object layer (in this case, an object layer is divided into several correction-regions) and that the different correction-regions are corrected differently depending on their position in the object layer. In these cases, different correction functions f can be used for different correction-regions so that different correction factor modules are determined for different correction-regions (i.e. so that different correction-regions are corrected individually).

Preferably, therefore, different target-temperature maps are assigned to correction-regions, in particular in different rows on a construction field. Alternatively or additionally, different correction factor modules are used for these different correction-regions. It is preferred that the assignment of a target-temperature map to a correction-region and/or the use of a correction factor module for a correction-region depends on a gas flow direction and/or gas distribution and/or a temperature distribution of the environment and/or a heat distribution or dissipation in the object.

Alternatively or additionally, it is preferred that a correction function f also depends on temperature data from a correction-region that was additionally (e.g. subsequently) defined as a reference-region. It is possible for a correction factor module to be determined for a correction-region based on temperature data from a reference-region and from a target-temperature map for the correction-region and for the correction-region to be consolidated in accordance with the correction factor module. When the correction factor module is determined, temperature data can be recorded and this temperature data can be used to determine a correction factor module for a different correction-region. This means that the correction-region for another correction-region is set as the reference-region.

Alternatively or additionally, it is preferred that the temperature data of different reference ranges are weighted differently in a correction function. The temperature data can be weighted in a correction function using weighting factors, e.g. a weighting factor can be assigned to the temperature data depending on its reference-region. The correction function can depend on these weighting factors and/or the temperature data or their values can be modified (multiplied) by the weighting factors. It is possible for temperature data from correction-regions that are located at different positions on the construction field to be assigned weighting factors according to the position of the reference-region corresponding to the temperature data on the construction field. This can, for example, be related to a gas flow direction or distribution and/or a temperature distribution and/or the heat distribution or dissipation in the component. It is also possible that the weighting factors are assigned to the temperature data depending on the order in which the reference-regions corresponding to the temperature data are determined.

For example, it can be assumed that the reference-region RB₁ of object 1 and the correction-regions KB₂ and KB₃ of the corresponding objects 2 and 3 (of the same shape and/or size) are in the same layer. In a simple case, the correction factor module (KFM) for the correction-regions KB₂ and KB₃ could be one and the same and depend on the temperature data (WD) from the reference-region RB₁ and a common target-temperature map (SW). This results in

$$KFM ( {KB}_{2} ) = KFM ( K {B}_{3} ) = f ( WD ( R {B}_{1} ) , SW )$$

The common target-temperature map can be a single value or a heat distribution. If there are different target-temperature maps (SW(KB₂) and SW(KB₃)) for the correction-regions KB₂ and KB₃, this would result in different correction factor modules (KFM(KB₂) and KFM(KB₃)):

KFM(KB₂)=f(WD(RB₁),SW(KB₂)) and KFM(KB₃)=f(WD(RB₁),SW(KB₃))

It should be noted that there may be a location dependency on x, y (the construction field) and also on the height z (i.e. the layer). The following would then apply:

f→f(x,y,z),WD→WD(x,y,z),SW→SW(x,y,z) and KBM→KBM(x,y,z)

It is preferred that in one embodiment of the method, shape-regions of a group of shape-regions are located in different layers, in particular reference-regions of these shape-regions are located in different layers, and a number of correction factor modules for correction-regions of a current layer are generated based on temperature data of a reference-region of the same group of shape-regions of an underlying layer. This opens up the possibility, for example, of positioning objects at different heights, considering the lowest objects as test objects and collecting data on some object layers before the remaining objects are manufactured. For example, if there are three objects that are each one object layer away from each other, then one object layer of the lowest object can be produced as a reference layer and the corresponding object layer of the second lowest object is solidified with corrected irradiation values (correction-region and reference-region at the same time). Further object layers of the two objects can now be solidified and, in particular, the effects of the correction on a subsequent object layer can be checked before the first object layer of the third object is corrected.

It is preferred that a number of objects are arranged at different heights. Furthermore, it is preferred that a correction factor module for a correction-region is generated as a function of the height of a reference-region and/or the correction-region. For example, the heat balance of a layer that lies directly on the building board is different from that of a layer that rests on support structures or a powder layer. This can be taken into account by including the height.

Preferably, a correction factor module for a correction-region is generated depending on the order in which the correction-regions are solidified. Alternatively or additionally, a correction factor module for a correction-region is generated depending on the position (e.g. in the construction chamber (x, y, z) and/or relative to the direction of the gas flow) of the correction-region. Alternatively or additionally, a correction factor module for a correction-region is generated depending on support structures of the correction-region (e.g. present or absent, how large/long in relation to the object). Alternatively or additionally, a correction factor module for a correction-region is generated depending on a time interval between two successive irradiations of a respective object.

According to a preferred embodiment of the method, a correction factor module is determined from temperature data from several reference-regions or from other correction factor modules, preferably by averaging, which is preferably weighted.

For example, if shape-regions of object 1 and 2 in a layer are reference-regions RB₁ and RB₂ and a corresponding shape-region of object 3 is a correction-region, KB₃, the temperature data WD(RB₁) and WD(RB₂) from the two reference-regions RB₁ and RB₂ are preferably weighted differently when generating the correction factor module (KFM) for the correction-region KB₃. The correction factor module is therefore a correction function of the temperature data WD(RB₁) and WD(RB₂) as well as the corresponding weighting factors k₁ and k₂:

KFM(KB₃)=f(k₁,k₂,WD(RB₁),WD(RB₂),SW)

In particular, the correction factor module can be a correction function of the weighted average value from the temperature data:

$$KFM ( {KB}_{3} ) = f ( ( {k}_{1} \cdot WD ( {RB}_{1} ) + {k}_{2} \cdot WD ( {RB}_{2} ) ) / ( {k}_{1} - {k}_{2} ) , SW )$$

In one example, k₂ may be greater than k₁ because when the correction-region KB₃ is solidified, the ambient conditions, e.g. temperature conditions, are similar to the ambient conditions when the reference-region RB₂ is solidified. It is also possible for the temperature data from the reference-region RB₁ to be used to generate a correction factor module for the region of object 2 in the layer and for temperature data from the same region of object 2 to be recorded at the same time as it is solidified. This region of object 2 would therefore be both a correction-region and a reference-region. In this case, the temperature data from the correction/reference-region of object 2 is less meaningful than the temperature data from the reference-region RB₁ of object 1, because corrected process values have already been used for the solidification of the forming region of object 2 and for this reason the temperature data from the reference-region RB₁ would be given greater weight (i.e. k₁ is greater than k₂).

It is also possible to first determine correction factor modules for a correction-region separately from the temperature data of the reference-regions and then average this. This would look like this for the example above:

$$KFM 1 ( {KB}_{3} ) = f ( W D ( R {B}_{1} ) , SW ) and KFM 2 ( {KB}_{3} ) = f ( W D ( R {B}_{2} ) , SW )$$

$$KFM 1 ( {KB}_{3} ) = ( {k}_{1} \cdot KFM 1 ( {KB}_{3} ) + {k}_{2} \cdot KFM 1 ( {KB}_{3} ) ) / ( {k}_{1} + {k}_{2} )$$

Even further, it is possible to take the changes in the order in the different layers into account when generating the correction factor module. As already mentioned, it is possible to vary the order of irradiation in the different layers, selecting a region of a different object in each layer as the reference-region.

Taking the change of sequence into account can also mean that the correction factors of the correction factor modules (or the corrected irradiance values) depend on the time interval between two successive irradiations of the same object (in particular two successive object layers of the same object).

For example, two layers A and B of three objects are considered, in each of which a shape-region group has been defined, wherein the shape-regions of the two groups are object layers lying on top of each other. RB_{1A} is the reference-region for the correction-regions KB_{2A} and KB_{3A} in the lower layer A. In the next layer B, the shape-region of object 2, which lies above KB_{2A}, was selected as the reference-region RB_{2B} for the correction-regions KB_{1B} and KB_{3B} of the other two objects, which also lie above the aforementioned regions. Let the solidification sequence be: RB_{1A}, KB_{2A}, KB_{3A}, application of new layer of building material, RB_{2B}, KB_{3B} and KB_{1B}.

An irradiation interval (the irradiation time of RB_{2B}) plus the coating interval therefore elapses between the irradiation of KB_{3A} and KB_{3B} and four irradiation intervals (the irradiation times for KB_{2A}, KB_{3A}, RB_{2B} and KB_{3B}) plus the coating interval elapse between the irradiation of RB_{1A} and KB_{1B}, At the time of the respective solidification, KB_{3B} is hotter than KB_{1B}, because KB_{1B} is irradiated after an approximately four times longer time interval than KB_{3B}, As a result, RB_{1A}, which lies below KB_{1B}, was able to release more heat than KB_{3A}, which lies below KB_{3B}.

Therefore, in such a case, the correction factor module is preferably generated in such a way that the elapsed time of solidification of the relevant lower object layer is also taken into account for a correction-region. This can have an effect on an irradiation intensity and/or a scanning speed. In the preceding example, the correction factor module is therefore generated in such a way that the resulting corrected irradiation values for KB_{3B} have a smaller irradiation intensity and/or a greater scanning speed than corrected irradiation values of a correction factor module that does not take the irradiation sequence into account. The corrected irradiance values for KB_{1B}, on the other hand, have a greater irradiance and/or a lower scan speed than those of the correction factor module for KB_{3B}. In this way, it is possible to compensate for thermal effects that occur due to the irradiation sequence.

In an example of another preferred embodiment, the height of an object layer or its surroundings is taken into account. If, for example, three reference-regions are compared, one of which is located directly on a building platform, the other on support structures or an un-solidified powder layer and the third on a solidified layer, the data of the reference-region whose environment is most similar to that of the correction-region could be selected for a correction factor module for a correction-region or taken into account by weighting factors. If the correction-region is located on support structures, for example, the second reference-region could be preferred.

In an example of a further preferred embodiment, the position in the building chamber is particularly taken into account. Some properties of the objects (e.g. their porosity) may depend on their position in the building chamber or on their position relative to the direction of the gas flow. Two or more reference-regions at different positions are preferably selected here, these positions differing systematically with regard to the temperature data to be expected, in particular at positions where the greatest differences in temperature data are to be expected. These are, for example, the first and last series or the closest object to the gas inlet and the object furthest away from the gas inlet. A correction factor module is then preferably determined from a weighting of the temperature data of the reference-regions, wherein the weighting depends on the position of the correction-region in question relative to the reference-regions. In particular, the closest reference-region is given the highest weighting.

Preferably, a correction-region is selected as a reference-region at (i.e. directly after or during) its solidification for generating a correction factor module, temperature data of this reference-region is recorded and this temperature data is used in a generation of a number of correction factor modules for solidifying other correction-regions. This allows an iterative correction to be realized. Since corrected irradiation parameters are used to solidify a correction-region, temperature data from this correction-region can serve as a measure of the quality of the correction and can be used to create an improved correction factor module. The correction-region in question therefore also serves as a reference-region.

It is possible that there is a special area in a shape-region that must be systematically corrected differently than another region (“normal-region”) of the shape-region. This can be the edge, for example, where the temperature data is falsified by the fact that the edge of a grayscale image can run right through pixels whose gray values are then systematically falsified by colder surrounding material.

For this purpose, it is preferred that a correction factor module is generated based on different correction functions. For example, one correction function f can be applied to the inside of an object and another correction function g to its edge. Preferably, a correction factor module is generated with the following steps:
Subdivide a number of correction-regions into a number of normal regions in which the temperature data lies within a specified value range around a value corresponding to the value of the target temperature map and a number of special regions in which the temperature data lies outside the value range,
Generating the correction factor module in such a way that a first correction function is used for the number of normal regions and a second correction function is used for the number of special regions, wherein the first correction function and the second correction function differ from each other.

The “Number of correction-regions” should include the correction-regions to which the correction factor module is to be applied. However, as the correction-regions are shape-regions (i.e. all identical or at least similar), basically any shape-region could also be used for this purpose.

The subdivision of correction-regions is done in such a way that it is basically determined where the correction was alright (normal regions) and where it was not. A special region can now be strictly any region in which the temperature data lie outside the value range. However, in order to compensate for outliers in the data, “potential special regions” could also be defined beforehand, which would become special regions completely if the majority of the area there was outside the value range. A potential special region could be an edge region, a closed region below a specified region, or structures with an acute angle below a specified number of degrees.

The correction factor module can then be generated, for example, in such a way that the correction function f from the correction factor module of the reference-region from which the temperature data originates is used for a normal region (after all, it was a correction-region before it was solidified). The correction function g for a special region could then be determined individually, in particular by modifying the other correction function f.

For a correction-region that is corrected with this correction factor module, a normal region is then corrected based on the corresponding correction function f and a special region is corrected based on the corresponding correction function g.

### BRIEF DESCRIPTION OF THE DRAWINGS

The invention is explained in more detail below with reference to the attached figures using examples of embodiments. In the various figures, identical components are provided with identical reference numerals. The figures are generally not to scale. They show

FIG. 1 a schematic view, partially shown in section, of an example of a device for additive manufacturing,

FIG. 2 a top view of an arrangement of objects in layers,

FIG. 3 three layers with object layers, reference-regions and correction-regions,

FIG. 4 shape-regions within an object with a change of reference-region,

FIG. 5 an arrangement of objects and change of reference-regions within an object and possibly also between objects in top view,

FIG. 6 a block diagram of the method as a regulation method and alternatively as a training method,

FIG. 7 reference-regions and correction-regions in differently positioned objects.

### DETAILED DESCRIPTION OF THE EMBODIMENTS

The following embodiments are described with reference to a device 1 for additive manufacturing of components in the form of a selective laser sintering or laser melting device, it being explicitly pointed out once again that the invention is not limited to selective laser sintering or laser melting devices. The device is therefore referred to in the following-without limiting the generality—as “manufacturing device” 1 for short.

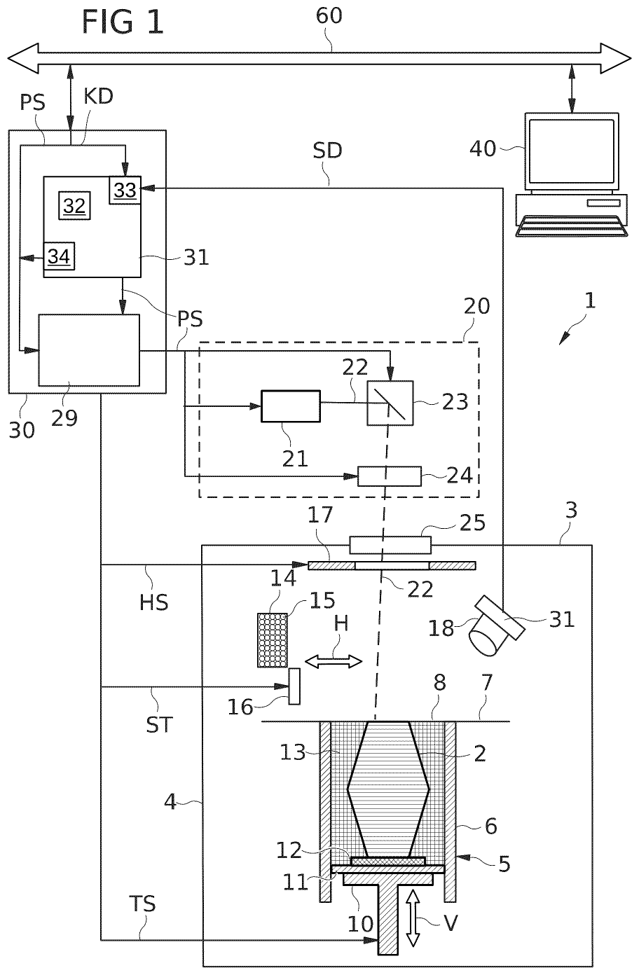

Such a manufacturing device 1 is shown schematically in FIG. 1. The device has a process chamber 3 or a process space 3 with a chamber wall 4, in which the manufacturing process essentially takes place. An upwardly open container 5 with a container wall 6 is located in the process chamber 3. The upper opening of the container 5 forms the current working plane 7. The area of this working plane 7 located inside the opening of the container 5 can be used to construct the object 2 and is therefore referred to as the construction field 8.

The container 5 has a base plate 11 movable in a vertical direction V, which is arranged on a carrier 10. This base plate 11 closes the container 5 at the bottom and thus forms its base. The base plate 11 can be formed integrally with the carrier 10, but it can also be a plate formed separately from the carrier 10 and attached to the carrier 10 or simply mounted on it. Depending on the type of specific building material, for example the powder used, and the manufacturing process, a building platform 12 can be attached to the base plate 11 as a building base on which the object 2 is built. In principle, however, the object 2 can also be built on the base plate 11 itself, which then forms the building base.

The basic construction of the object 2 is carried out by first applying a layer of building material 13 to the building platform 12, then—as explained later—selectively solidifying the building material 13 with a laser beam 22 as an energy beam at the points which are to form parts of the object 2 to be manufactured, then lowering the base plate 11, and thus the building platform 12, with the aid of the carrier 10 and applying a new layer of the building material 13 and selectively solidifying it, and so on. In FIG. 1, the object 2 built up in the container on the building platform 12 below the working level 7 is shown in an intermediate state. It already has several solidified layers, surrounded by un-solidified building material 13. Various materials can be used as building material 13, preferably powder, in particular metal powder, plastic powder, ceramic powder, sand, filled or mixed powders or also pasty materials and optionally a mixture of several materials.

Fresh building material 15 is located in a storage container 14 of the production device 1. The building material can be applied in the working plane 7 or within the construction field 8 in the form of a thin layer with the help of a layering device 16 that can be moved in a horizontal direction H.

Optionally, there is an additional radiation heater 17 in the process chamber 3, which can be used to heat the applied building material 13 so that the irradiation device used for selective solidification does not have to introduce too much energy. This means, for example, that a quantity of basic energy can already be introduced into the building material 13 with the aid of the radiation heater 17, which is of course still below the energy required for the building material 13 to fuse or sinter. For example, an infrared heater or VCSEL emitter can be used as the radiation heater 17.

For selective solidification, the manufacturing device 1 has an irradiation device 20 or, more specifically, an exposure device 20 with a laser 21. This laser 21 generates a laser beam 22, which is deflected by a deflection device 23 in order to scan the exposure paths or tracks (hatch lines) in the layer to be selectively solidified in accordance with the exposure strategy and to selectively introduce the energy. Further, this laser beam 22 is suitably focused onto the working plane 7 by a focusing device 24. The irradiation device 20 is preferably located here outside the process chamber 3 and the laser beam 22 is guided into the process chamber 3 via a coupling window 25 provided in the chamber wall 4 at the top of the process chamber 3.

For example, the irradiation device 20 may comprise not just one, but several lasers. Preferably, these may be gas or solid-state lasers or any other type of laser such as laser diodes, in particular VCSEL (Vertical Cavity Surface Emitting Laser) or VECSEL (Vertical External Cavity Surface Emitting Laser) or a line of these lasers. Most preferably, one or more unpolarized single-mode lasers, e.g. a 3 kW fiber laser with a wavelength of 1070 nm, can be used in the context of the invention.

The production is monitored with the sensor arrangement 18. This can comprise, for example, a radiation sensor, e.g. a thermal imaging camera, and measures spatially resolved temperature data of a number of regions (reference-regions) of a component layer B.

The units of the manufacturing device 1 are controlled by a control device 30 comprising a control unit 29, which controls the components of the irradiation device 20, namely in this case the laser 21, the deflection device 23 and the focusing device 24, and transmits corresponding control data PS to them for this purpose.

The control unit 29 also controls the radiation heater 17 by means of suitable heating control data HS, the layering device 16 by means of layering control data ST and the movement of the carrier 10 by means of carrier control data TS, thus controlling the layer thickness.

The control device 30 is coupled, here for example via a bus 60 or another data connection, to a terminal 40 with a display or the like. Via this terminal 40, an operator can control the control device 30 and thus the entire laser sinter device 1, for example by transmitting process control data PS.

The control device 30 comprises a control device 31 according to the invention for controlling the irradiation. The control device 31 comprises a provision-unit 32, the sensor unit 18, a correction module unit 33 and a control data unit 34.

The provision-unit 32 is designed to specify a number of ranges or target values that are required for the correction. Everything can be predefined at the start of the process, but can also be additionally predefined during the process. The provision-unit has the following tasks:
Determining a plurality of shape-regions corresponding to each other in shape and/or size in the object layers O to be solidified,
selecting a number of reference-regions R from the plurality of shape-regions, at least the remaining shape-regions being defined as correction-regions K,
   determining a number of target-temperature maps S which specify a desired heat distribution of correction-regions K or a number of groups of correction-regions K.

The sensor unit 18 is designed to record spatially resolved temperature data W of the number of reference-regions R as they solidify. During the solidification of a component layer, for example, it can record this in the form of a film or many images. The individual images can then be used to compile the temperature data from the section that has just been solidified.

The correction module unit 33 is used to generate a number of correction factor modules F for the correction-regions K from the temperature data W and the target-temperature maps S, wherein each correction factor module F specifies spatially resolved correction factors for irradiation values or spatially resolved corrected irradiation values and a correction factor module F is assigned to each correction-region K.

The control data unit 34 is used to generate and output control data for solidifying at least the correction-regions K based on the correction factor module F assigned to each of them.

It is also pointed out again at this point that the present invention is not limited to such a manufacturing device 1. It can be applied to other methods for generative or additive manufacturing of a three-dimensional object by layer-by-layer deposition and selective solidification of a building material, wherein an energy beam for solidification is emitted onto the building material to be solidified. Accordingly, the irradiation device may also not only be a laser as described herein, but any device that can be used to selectively apply energy as wave or particle radiation to or into the building material could be used. For example, another light source, an electron beam, etc. could be used instead of a laser.

Even if only a single object 2 is shown in FIG. 1, it is preferable to produce several objects in the process chamber 3 or in the container 5 in parallel. For this purpose, the building material is scanned layer by layer by the energy beam 22 at points that correspond to the cross-sections of the objects in the respective layer.

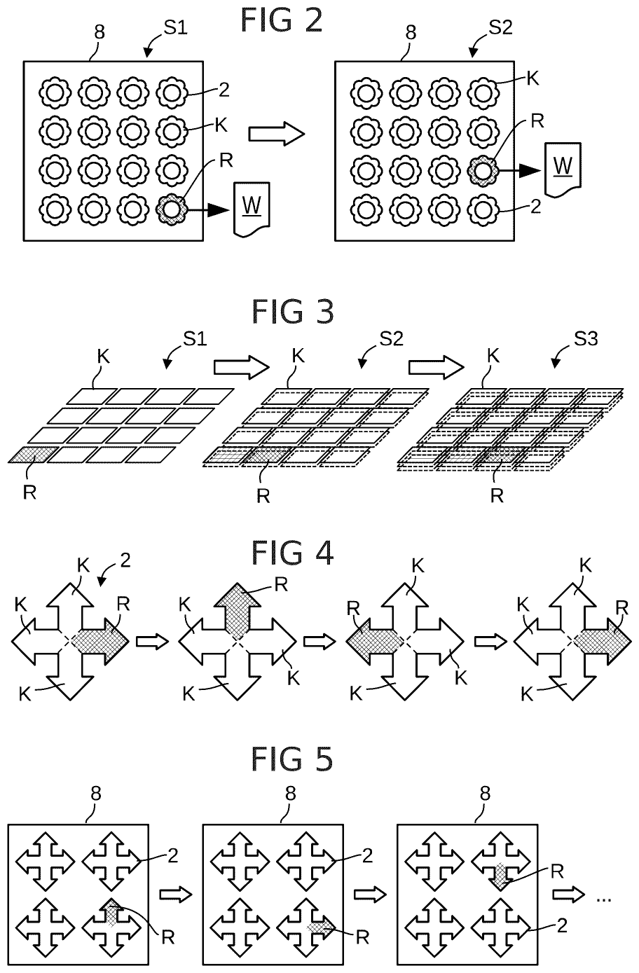

FIG. 2 shows a top view of an arrangement of objects 2 in layers on a construction field 8. A total of 16 identical objects 2 are produced. In the layer S1 shown on the left, 16 identical shape-regions can be seen. The shape-region of object 2 in the lower right corner is selected here as reference-region R and has already been solidified. The hatching is intended to represent the heat distribution, which is recorded in the form of temperature data W. The other shape-regions are correction-regions whose irradiation is corrected with this temperature data.

In the layer S2 shown on the right, the reference-region R in the object 2 is above the object 2 in the left-hand layer S1. This layer is thus solidified on an already corrected and thus thermally adjusted layer, so that thermal distortion is less than if only the object 2 in the lower right corner is used as a reference.

FIG. 3 shows three layers with object layers O, reference-regions R and correction-regions K. Here, the reference-region is in the bottom line and moves one place further to the right with each layer S1, S2, S3 from the bottom left corner. The aim here is to show the distortion of the heat of an object layer O due to an incorrect heat input.

In the left layer, the reference-region R was irradiated incorrectly, e.g. too warm, which could be corrected in the correction-regions K. In the next layer S2 (center), some of the excess heat from the lower layer S1 still penetrates into the now solidified object layer O in the lower left corner (thin hatching). It is therefore advisable to select a different reference-region R, e.g. the one to the right.

In the right-hand image, there is still a small thermal irritation in the bottom left-hand corner. Therefore, a reference-region R is selected in another object (next to the right). Theoretically, in the next layer, the reference-region could again be selected from object 2 at the bottom left, so that you end up with three “sacrificial objects” and the remaining objects have been optimally manufactured.

FIG. 4 shows shape-regions within an object 2 with a change of reference-region R. A symmetrical object 2 with four identical shape-regions is shown here. The dashed cross in the middle is merely intended to visually separate the shape-regions. In contrast to FIG. 3, it is now possible to select a different shape-region of the same object 2 as reference-region R in each layer. As suggested for FIG. 3, the process starts again from the beginning after three layers, so that the downward-pointing arrow shape is never a reference-region. In practice, however, it is advisable to select a reference-region R in turn.

FIG. 5 shows an arrangement of objects and changing reference-regions within an object 2 and possibly also between objects 2 in top view. The shape of FIG. 4 is produced four times here, with the reference-region R always changing. In the right-hand illustration, it is indicated that the reference-region R does not only have to be selected in the same object O.

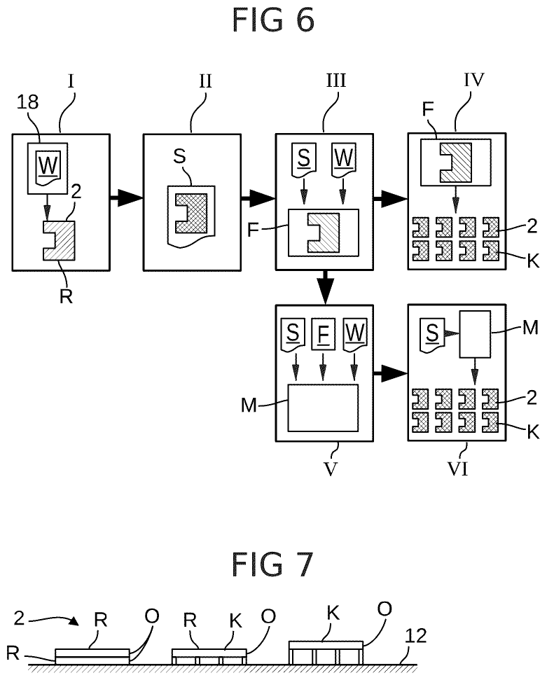

FIG. 6 shows a block diagram of the process as a regulation process and alternatively as a training process.

In step I, a reference-region R is solidified and spatially resolved temperature data W of the number of reference-regions is recorded during (i.e. after or during) their solidification. The temperature data W can, for example, represent a grayscale image.

In step II, a target-temperature map S is determined, which is to apply to all forming areas of the manufactured objects O. This target-temperature map specifies a desired heat distribution of correction-regions K.

In step III, a correction factor module F is generated for the correction-regions K from the temperature data W and the target-temperature maps S. The correction factor module F specifies spatially resolved correction factors for irradiation values and is assigned to each correction-region K.

The process is now split into two possible strands.

In step IV, correction-regions K of other objects 2 are corrected based on the correction factor module F, thus optimizing their quality.

In the alternative strand, a machine learning model M is trained in step V with the temperature data, the target-temperature map and the correction factor module F. The temperature data W of the correction-regions produced in step IV can also be added (these correction-regions would then also be reference-regions R).

In step IV, correction-regions K of other objects 2 are corrected based on temperature data and the trained model M, thus optimizing their quality.

FIG. 7 shows reference-regions R and correction-regions K in differently positioned objects 2. An object 2 is shown on the left, in which a reference-region R (bottom) is located on a building platform 12. There, the heat dissipation downwards is very good and the temperature data of this reference-region R may not be representative for other regions. In this object 2, a reference-region R (top) is also shown that lies on a solidified region. The component 2 in the center has a shape-region that is both a reference-region R and a correction-region K. The object layer O in question rests on spacers. If you compare this structure with the object to the left of it, the upper reference-region R there could perhaps be used for correction. It would be best to use the reference-region R of the middle object O to correct the correction-region K of the right object 2, as the structure with the spacers is corresponding.

It would also be possible to take all reference-regions R into account for the correction of the correction-region K, wherein the temperature data from the reference-regions or the correction factor modules based on them are each weighted differently and wherein the temperature data or the correction factor module of the reference-region R of the middle object O is preferably assigned a greater weighting than the temperature data or the correction factor modules of the other reference-regions.

Finally, it should be pointed out once again that the devices described in detail above are merely examples of embodiments which can be modified by the skilled person in a wide variety of ways without departing from the scope of the invention. For example, solidification could also be carried out using other energy beams instead of laser light. Furthermore, the use of the indefinite articles “a” or “one” does not exclude the possibility that the features in question may be present more than once. Likewise, the term “unit” does not exclude the possibility that it consists of several interacting sub-components, which may also be spatially distributed. The term “a number” is to be understood as “at least one”. Irrespective of the grammatical gender of a particular term, persons with male, female or other gender identities are included.

### LIST OF REFERENCE SIGNS

1 Manufacturing device/laser sinter device
2 Object
3 Process space/process chamber
4 Chamber wall
5 Container
6 Container wall
7 Working plane
8 Construction field
10 Carrier
11 Base plate
12 Building platform
13 Building material (in container 5)
14 Storage container
15 Building material (in storage container 14)
16 Layering device
17 Radiation heater
18 Sensor unit
20 Irradiation device
21 Laser
22 Beam
23 Deflection device/scanner
24 Focusing device
25 Coupling window
29 Control unit
30 Control device
31 Regulation device
32 Provision-unit
33 Correction module unit
34 Control data unit
40 Terminal
60 Bus
F Correction factor module
H Horizontal direction
HS Heating control data
K Correction-region
KD Process space control data set
M Machine learning model
O Object layer
PS Process control data
R Reference-region
S Target temperature map
S1, S2, S3 Layer
SD Process space sensor data set
ST Layering control data
T Carrier control data
V Vertical direction
W Temperature data

What is claimed is:

1. A method for regulating an irradiation in a manufacturing process for the additive manufacturing of objects, wherein building material is solidified layer by layer in a construction field in the form of object layers, corresponding to cross-sections of the objects to be manufactured, by means of irradiation of the building material, the method comprising the steps:
determining a plurality of shape-regions corresponding to each other in shape and/or size in the object layers to be solidified,
selecting a number of reference-regions from the plurality of shape-regions, at least the remaining shape-regions being defined as correction-regions,
determining a number of target-temperature maps which specify a desired heat distribution of correction-regions or a number of groups of correction-regions,
solidifying a number of selected reference-regions and recording spatially resolved temperature data of the number of reference-regions as they are solidified,
generating a number of correction factor modules for the correction-regions from the temperature data and the target-temperature maps, wherein each correction factor module specifies spatially resolved correction factors for irradiation values or spatially resolved corrected irradiation values and assigns a correction factor module to each correction-region,
solidifying at least the correction-regions based on the respectively assigned correction factor module.

2. The method according to claim 1, wherein a plurality of groups of shape-regions are defined in different layers and the method steps are carried out for each group of shape-regions, wherein groups of shape-regions are respectively defined in S superimposed layers, so that a plurality of stacks of shape-regions are present, which are formed from superimposed shape-regions of different groups of shape-regions,
wherein from each group of shape-regions a plurality of shape-regions in N shape-region stacks are selected and from the selected shape-regions in each layer M reference-regions are selected with M<N,
wherein the shape-region stacks correspond to the object layers of an object and/or an object is divided into a plurality of shape-region stacks.

3. The method according to claim 1, wherein for a current layer a plurality of reference-regions is selected from the shape-regions of the layer and temperature data of these reference-regions are recorded and/or temperature data of reference-regions of a number of layers under the current layer are provided, and correction factor modules for the correction-regions of the current layer are generated from these temperature data and the relevant target-temperature maps,
wherein a weighted average value is calculated from the temperature data or several correction factor modules are first calculated for different temperature data and a weighted average value is calculated from these correction factor modules.

4. The method according to claim 1, wherein a correction factor module KFM for a correction-region KB is determined by means of a correction function f from the temperature data WD(RBᵢ) of a number of n reference-regions RBᵢ and the target-temperature map SW(KB) for this correction-region KB according to KFM(KB)=f(WD(RB₁), WD(RB₂), . . . . WD(RBₙ), SW(KB)), wherein
different correction functions f are used for different correction-regions and/or
a correction function f additionally depends on temperature data of a correction-region, which was additionally defined as a reference-region and/or
the temperature data of different reference-regions are weighted differently in a correction function.

5. The method according to claim 1, wherein shape-regions of a group of shape-regions are located in different layers, wherein reference-regions of these shape-regions are located in different layers, and a number of correction factor modules for correction-regions of a current layer are generated based on temperature data of a reference-region of the same group of shape-regions of an underlying layer,
wherein a number of objects are arranged at different heights, wherein a correction factor module for a correction-region is generated as a function of the height of a reference-region and/or the correction-region.

6. The method according to claim 1, wherein a correction factor module for a correction-region is generated depending on
the order of solidification of the correction-regions and/or
the position of the correction-region and/or
support structures of the correction-region and/or
a time interval between two successive irradiation of an object in question.

7. The method according to claim 1, wherein a correction factor module is determined from other correction factor modules by averaging.

8. The method according to claim 1, wherein a correction-region is selected as a reference-region during its solidification for generating a correction factor module, temperature data of this reference-region is recorded and this temperature data is used in a generation of a number of correction factor modules for solidifying other correction-regions.

9. The method according to claim 1, wherein correction-regions in different rows on a construction field, are assigned different target-temperature maps and/or wherein different correction factor modules are used for these correction-regions,
wherein the assignment of a target-temperature map to a correction-region and/or the use of a correction factor module for a correction-region depends on a gas flow direction and/or a gas distribution and/or a temperature distribution of the environment and/or on a heat distribution or dissipation in the object.

10. The method according to claim 1, wherein the generation of a correction factor module is based on different correction functions and on temperature data of a reference-region which is a solidified correction-region, wherein a correction factor module is generated with the following steps:
dividing a number of correction-regions into a number of normal regions, in which the temperature data lies within a predetermined value range around a value of the target temperature map corresponding to this range, and into a number of special regions, in which the temperature data lies outside the value range,
generating the correction factor module in such a way that a first correction function is used for the number of normal regions and a second correction function is used for the number of special regions, wherein the first correction function and the second correction function differ from each other.

11. A regulation device for regulating an irradiation in a manufacturing process for the additive manufacturing of objects, wherein building material is solidified layer by layer in a construction field in the form of object layers, corresponding to cross-sections of the objects to be manufactured, by means of irradiation of the building material, the regulation device comprising:
a provision-unit designed for
i) determining a plurality of shape-regions corresponding to each other in shape and/or size in the object layers to be solidified,
ii) selecting a number of reference-regions from the plurality of shape-regions, at least the remaining shape-regions being defined as correction-regions,
iii) determining a number of target-temperature maps which specify a desired heat distribution of correction-regions or a number of groups of correction-regions,
a sensor unit designed for recording spatially resolved temperature data of the number of reference-regions as they are solidified,
a correction module unit designed for generating a number of correction factor modules for the correction-regions from the temperature data and the target-temperature maps, wherein each correction factor module specifies spatially resolved correction factors for irradiation values or spatially resolved corrected irradiation values and assigns a correction factor module to each correction-region,
a control data unit designed for generating and outputting control data for solidifying at least the correction-regions based on the respectively assigned correction factor module.

12. The regulation device according to claim 11, comprising a machine learning model which has been trained.

13. A control device for a manufacturing device for the additive manufacturing of objects, wherein the control device comprises a regulation device according to claim 11 and/or is designed to control the manufacturing device.

14. A manufacturing device for the additive manufacturing of at least one object in an additive manufacturing process comprising at least
an irradiation device for solidifying building material layer by layer by irradiation with at least one energy beam, and
a control device according to claim 13.

15. A computer program product comprising instructions which, when the program is executed by a computer, cause the computer to perform the steps of the method according to claim 1.
